(19) United States
(12) Patent Application Publication
(10) Pub. No.: US 2004/0037448 A1
(43) Pub. Date: Feb. 26, 2004

(54) Digitally watermarking paper and objects with stamps and related digitally watermarked stamper

(76) Inventor: Trent J. Brundage, Tigard, OR (US)

Correspondence Address: DIGIMARC CORPORATION, 19801 SW 72ND AVENUE, SUITE 100, TUALATIN, OR, 97062, US

(21) Appl. No.: 10/453,876

(22) Filed: Jun. 2, 2003

Related U.S. Application Data
(60) Provisional application No. 60/390,716, filed on Jun. 20, 2002.

(51) Int. Cl. G06K 9/00

(52) U.S. Cl. 382/100

(57) ABSTRACT

The present invention provides steganographic embedding techniques. In particular, the present invention provides a stamper (e.g., a rubber stamp) that includes a steganographic signal (e.g., a digital watermark) embedded in a stamping surface pattern thereof. The digital watermark survives in its host pattern when the stamper stamps the host pattern. The digital watermark can be used to authenticate or identify the stamper. The digital watermark can also be used to link to related information.

### RELATED APPLICATION DATA

The present invention claims the benefit of U.S. Provisional Patent Application No. 60/390,716, filed Jun. 20, 2002. The present application is also related to U.S. patent application Ser. No. 10/074,680, filed Feb. 11, 2002 (published as US 2002/0136429 A1). The present invention is also related to the assignee's U.S. patent application Ser. Nos.: 09/689,226, filed Oct. 11, 2000; 10/052,895, filed Jan. 17, 2002 (published as US 2002/0105679 A1); Ser. No. 09/840,016, filed Apr. 20, 2001 (published as US 2002/0054355 A1); and 09/074,034, filed May 6, 1998 (now U.S. Pat. No. 6,449,377). Each of these patent documents is herein incorporated by reference.

### FIELD OF THE INVENTION

The present invention relates to steganography and digital watermarking.

### BACKGROUND AND INVENTION SUMMARY

Digital watermarking is a process for modifying physical or electronic media to embed a machine-readable code into the media. The media may be modified such that the embedded code is imperceptible or nearly imperceptible to the user, yet may be detected through an automated detection process. Most commonly, digital watermarking is applied to media signals such as images, audio signals, and video signals. However, it may also be applied to other types of media objects, including documents (e.g., through line, word or character shifting, background texturing), software, multi-dimensional graphics models, and surface textures of objects.

Digital watermarking systems typically have two primary components: an encoder that embeds the watermark in a host media signal, and a decoder that detects and reads the embedded watermark from a signal suspected of containing a watermark (a suspect signal). The encoder embeds a watermark by altering the host media signal. The reading component analyzes a suspect signal (e.g., perhaps from optically captured image data) to detect whether a watermark is present. In applications where the watermark encodes information, the reader extracts this information from the detected watermark.

Several particular watermarking techniques have been developed. The reader is presumed to be familiar with the literature in this field. Particular techniques for embedding and detecting imperceptible watermarks in media signals are detailed in the assignee's co-pending U.S. patent application Ser. No. 09/503,881 and U.S. patent application Ser. No. 6,122,403, which are each herein incorporated by reference. Even more watermarking techniques are disclosed in the related applications mentioned above.

(I also refer the interested reader to assignee's U.S. patent application Ser. No. 09/515,545, filed Feb. 29, 2000, titled “Method and Apparatus for Encoding Paper with Information,” which is herein incorporated by reference. In that application assignee's inventor discussed a technique where a so-called de-watering element in a paper making process is used to impart a pattern or texture to a paper's surface. The de-watering element can be shaped according to a digital watermark signal to impart the watermark signal in the pattern or texture.).

Assignee has previously disclosed that objects can be encoded with digital watermarks. For example, in assignee's U.S. patent application Ser. No. 09/690,773, which is herein incorporated by reference, assignee disclosed that stickers can include a digital watermark. Stickers in all their varieties have found an enduring place in our society. From the workplace (Post-It® brand message notes), to kids in a classroom, stickers have an inherit value associated with them, whether it be functional (seals, labels, etc.) or just to identify yourself with a particular affinity group (bumper stickers on cars). By placing a watermark on stickers they can be used in novel ways. By encoding a set of stickers with a watermark during production, specific machine behaviors can be assigned to them. These behaviors can be associated or even possibly changed by anyone from the manufacturer through the distributor, all the way to the end-user. In addition, the users can create their own watermark enabled stickers by creating an image, embedding a watermark in it, and associating the watermark with one or more machine behaviors.

These behaviors may include, but are not limited to the following:

Taking the user to a web-site linked to the watermark via a network address of the web-site or index to the network address.

Opening an email client to email to a specific person (e.g., a person whose email address is stored in the machine behavior description associated with the watermark).

Launching the user into an Interframe Relay Chat (IRC) session that other people with the same sticker can participate in.

Authenticating the user as part of a process of accessing a network resource, such as account information or access to a computer network.

Authentication the user in an electronic commerce transaction performed on a computer network.

Sending an electronic card.

Placing a phone or video-conference call.

As props in a computer game. For example, the prop is a multi-sided, or multi-faceted object, where each side or facet has a watermarked image conveying a different message used to control the game. The computer game includes a watermark decoder for extracting the messages from image frames captured of the prop. The message may directly carry the message or act as an index to a more detailed game instruction in a database, such as an instruction that changes over time based on changes to the corresponding database entry by the user or game manufacturer.

As a visual aide for disabled users.

Anywhere where machine vision is not feasible.

In each of the above applications, the watermark carries information that links the watermarked object (e.g., sticker) with a machine behavior. To trigger this behavior, a watermark decoder application captures an image or images of the watermarked sticker, extracts the watermark, and uses information embedded in the watermark to determine an associated machine behavior. The watermark decoder then takes action to initiate the machine behavior associated with the watermark.

For some applications, it is useful to enable the user to control the behavior associated with a watermarked object. This type of management may be handled by creating accounts for users and providing access to the accounts via some authentication method (email, passwords, etc.). For a number of reasons, these access methods can be problematic (losing passwords, asking kids for their email addresses, etc.). As an alternative, watermarks may be used to manage the process of associating behaviors with a watermarked object.

For example, in the scenario where a user wants to assign behaviors to a set of watermarked stickers they have received, they can hold up the first sticker (or its packaging), and be taken to a registration application to activate the stickers in the pack.

For more information about linking objects with machine behaviors or actions, see assignee's U.S. patent application Ser. No. 09/571,422, which is hereby incorporated by reference.

The present invention continues upon these inventive ideas. According to one aspect of the present invention, a stamper (e.g., a rubber stamp) is provided to include a digital watermark conveyed through its stamping surface. For example, the digital watermark may be embedded in a stamp graphic, pattern or image, or may be provided in a stamping surface texture, background tint or pattern. The digital watermark is transferred to paper or an object as the stamper stamps its stamp pattern. The digital watermark may include machine-readable code to achieve the linking functions envisioned above, among others. Imagine school age children, each with their own personalized stampers. Instead of trading her email address, Sue instead stamps her new friend, Kim's, notebook with her personalized, digitally watermarked stamper. Sue's stamper impresses (or stamps) a pattern onto Kim's notebook. The stamped pattern includes the digital watermark embedded therein. The watermark's machine-readable code may provide a link to Kim's website or provide a link to a personal chat room. The code may even cause Sue's computer to launch an email program, with an email message addressed to Kim.

So-called rubber stamping has developed into an art. Crafty stamp participants use rubber stamps to decorate cards, posters, artwork, etc. Digital watermarking can provide enhancements and interactive links. The digital watermark may also convey artist or copyright information.

Merchants use stampers to sign or endorse checks and other commercial paper. The merchant's stamper can stamp a personalized digital watermark. The personalization can be provided with a unique identifier (e.g., plural message bits). The identifier can be used to uniquely identify the merchant. Businesses that stamp incoming mail as received may include a stamp that has a watermark payload to convey an office location (or date/time) or other identifier.

Additional features and advantages of the present invention will become even more apparent with reference to the following detailed description and accompanying drawings.

### BRIEF DESCRIPTION OF THE DRAWINGS

FIG. 1 shows an example of an inventive stamper.

FIG. 2 illustrates an example of a digital watermark signal.

FIG. 3 illustrates a representation of the FIG. 2 watermark signal after thresholding.

FIG. 4 is a flow diagram for one aspect of the present invention.

FIG. 5 is a flow diagram for another aspect of the present invention.

### DETAILED DESCRIPTION

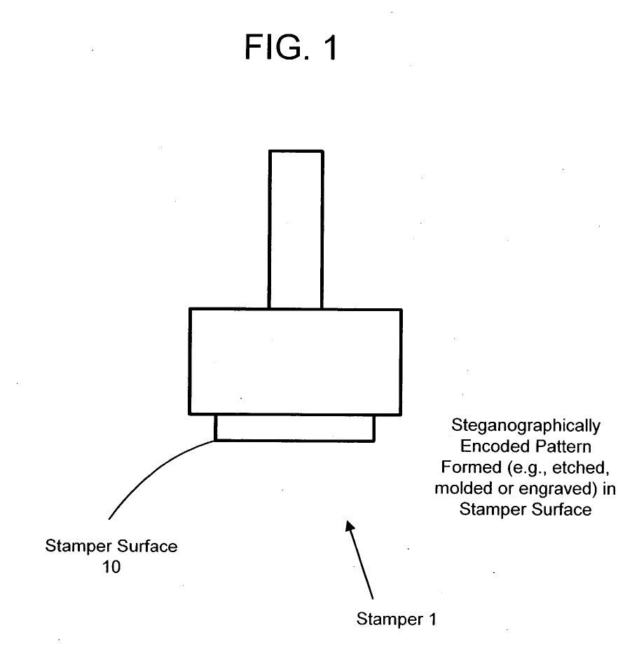

I have found that a physical stamper (e.g., a rubber stamp) can be provided so as to impart (e.g., stamp) a pattern or mark that includes a steganographic message (e.g., a digital watermark) embedded therein. The stamping surface is formed, molded or textured so as to include the steganographic signal embedded therein. The digital watermark is preferably visually imperceptible (or nearly imperceptible) as it is embedded in the pattern. Please note that I intend the use of the terms “stamper” and “rubber stamp” to represent a broad range of stampers with a basic requirement of begin able to impart or stamp a pattern or mark to a paper or object, e.g., with the aid of ink or dye. The present invention encompasses stampers in a variety of shapes and sizes, some stampers may even be automated, or made of differing materials. Accordingly, an example stamper shown in FIG. 1 is illustrative only, and is not intended to limit the present invention. In general, a stamper 1 includes a stamp surface 10 having a pattern etched (e.g., chemical, thermal or laser etching), cut or otherwise carved, molded, patterned or engraved therein. Some stamp surfaces are even created though injection molding. Instead of carving away material from a stamp surface, other stamp surfaces are created by adding shapes, lines, graphics or texturing to a base substrate. Although a stamper is often referred to as a “rubber stamp” the stamp surface can include materials other than rubber such as plastic, metal, wood, synthetics, felt, etc., etc. A typical stamping scenario involves providing ink or dye to a stamper surface and them pressing the inked stamper surface against paper or an object to transfer the ink or dye in the stamp pattern. The ink adheres to the pattern's raised edges or areas, while the pattern valleys and cervices provide an ink void in the pattern. Some stampers impress a pattern in an object or paper by force alone (e.g., embossing), and without any ink or dye. My techniques apply to these types of stampers as well.

My inventive stamp pattern includes a digital watermark embedded therein.

Steganographic Pattern Construction

Thresholding

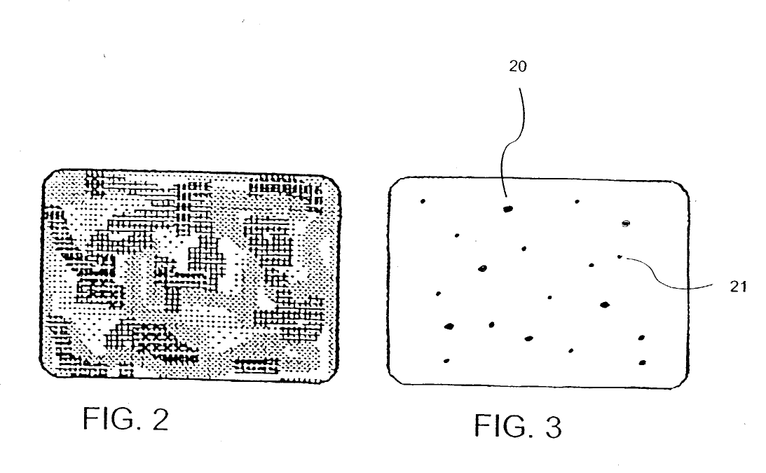

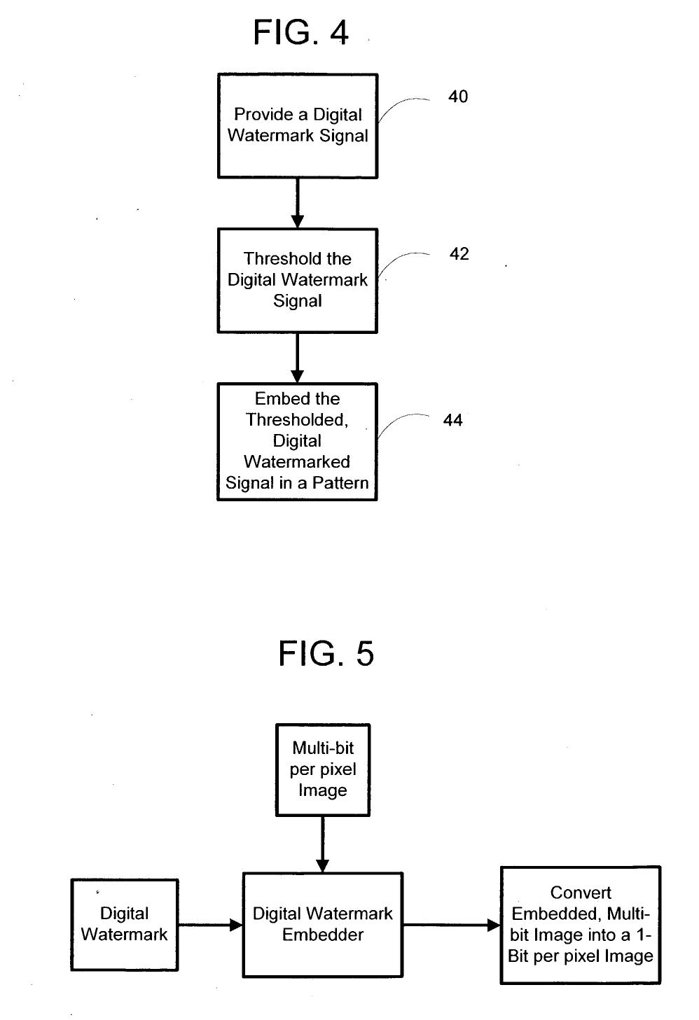

I now describe a stamping example for a thresholding-based pattern construction with reference to FIGS. 2-4. FIG. 4 illustrates a flow diagram depicting method steps for a first embodiment of the present invention. A digital watermark signal is provided in step 40 (FIG. 4). The digital watermark signal preferably includes a message component, e.g., a payload or identifier, and, if needed, an orientation component. An orientation component is helpful to resolve pattern distortion such as scale and rotation. FIG. 2 illustrates an example of a portion of a watermark signal shown in a spatial domain. (Note that the FIG. 2 representation is exaggerated to help simplify the discussion.). Although not required, the digital watermark signal is preferably a pure (or “raw”) signal in that it does not include image or pattern data. Of course, in some cases, e.g., as discussed below, a pure or raw signal may include base or flat image data.

Thresholding is applied to the FIG. 2 watermark signal (step 42 of FIG. 4). Thresholding preferable identifies (or reduces the watermark signal to) a set of relevant points or base signal characteristics (see, e.g., FIG. 3). The relevant points or characteristics may correspond to or represent a wide range of features, such as signal or frequency peak levels, magnitude peaks, watermark message components, watermark orientation references, spatial domain signal characteristics, etc. Regardless of the relevant features used to determine a relevant characteristic, the set of relevant characteristics is preferably sufficient to represent (or convey) the watermark signal. (I use the term “thresholding” generally herein to include a process to identify a set and/or location of spatial points. Alternatively, the thresholding may identify relevant frequency domain points, which can be mapped or transformed into a spatial domain representation.) A thresholding procedure can also be adjusted to provide a more or less robust watermark signal. For example, the spacing of relevant points can be increased, but at a cost of robustness. Please also note that in some implementations, the thresholding step normalizes a watermark signal. For example if the watermark signal comprises values of −1 and 1, the threshold may reduce the watermark values to 0 and 1. In one thresholding implementation I start with a gray or monotone image (e.g., a flat gray image including substantially uniform pixel values or subtly varying grayscale texture, tint or pattern). One can use standard image editing software such as Adobe's Photoshop or Jasc Software's PaintShop Pro, etc., etc. to provide the gray image. The gray image serves as a “host” image and is passed to a digital watermark-embedding module. The digital watermarking module can encode the gray image, e.g., based on a transform domain watermark embedding technique or spatial domain watermark embedding technique, etc. I can then “threshold” the embedded gray image prior to printing or engraving. Generally, thresholding reduces the watermark signal and/or watermarked image. In one implementation, a watermark signal is embedded as a plurality of peaks and valleys (or plus and minus signal tweaks). The tweaks can be encoded in the gray image by changing or effecting pixel values, e.g., changing gray-scale levels for pixels. (Please note that transform domain embedding also affects pixels values.). Thresholding this embedded gray image may then include selecting a grayscale level (e.g., level 128 in an 8-bit (or 256 level) grayscale image) and discarding all pixels with a grayscale level below (or above) level 128. Of course, there are many other thresholding techniques that can be employed such as filtering an embedded image, creating a binary image (e.g., toggling image pixels to be on or off based on pixel values of the embedded image), discarding pixels based on coefficient values (or blocks of coefficient values), etc., etc. In other implementations a steganographic pattern appears as (or includes) a background texture or tint. In other implementations the pattern appears as if a random (or pseudo-random) pattern.

While the term “thresholding” is used as an illustrative technique, the present invention is not so limited. Indeed there are other ways to refine a watermark signal into a set of relevant points. For example, a frequency analysis can be used to identify significant frequency characteristics (e.g., peaks). These characteristics can be mapped to the spatial domain to identify a spatial domain adjustment or placement location. Or, as in another implementation, a digital watermark signal is quantitized, e.g., via a root mean square measurement. Of course other techniques can be used to reduce a watermark signal to a set of relevant spatial points sufficient to convey the signal for machine-detection. In other implementations, I choose not to reduce or threshold a digital watermark signal prior to embedding in a host image, pattern or flat image.

The thresholded watermark signal is embedded into a pattern (FIG. 4, step 44). In most thresholding implementations, the pattern is a 1-bit image (or pattern). (In some cases the pattern is reversed to allow a properly aligned image or pattern when stamped.). The embedded pattern is used as a template to engrave (or etch, mold, cut, etc.) the stamper pattern surface. I have found that the embedded digital watermark survives the patterning process.

The digital watermark is transferred to paper or objects as the stamper stamps the embedded pattern onto the paper or objects.

Embedding Multi-Bit Images

In an alternative implementation, with reference to FIG. 5, a multi-bit image (e.g., 8-bit gray-scale image) is provided. The multi-bit image will be eventually serve as a template to form the pattern in the stamper stamp surface. The multi-bit image is embedded with a digital watermark signal. For example, the techniques disclosed in assignee's U.S. patent application Ser. No. 09/503,881 and U.S. patent application Ser. No. 6,122,403 are used to embed the multi-bit image. Of course, other embedding techniques can be suitably interchanged with this aspect of the present invention.

The embedded, multi-bit image is preferably reduced to a 1-bit per pixel image. (Please note that many commercially available image editing software packages, e.g., such as provided by Adobe, allow a user to reduce the bit depth of a digital image. I have found that a digital watermark, once embedded in a multi-bit image, can survive such a bit-per-pixel reduction.).

The reduced, 1-bit image is used as a pattern template to form the stamper stamp surface.

In an alternative implementation, the embedded multi-bit image is used as a pattern template without first converting to a 1-bit image. In a related implementation, a multi-bit (or 1-bit per pixel) pattern is etched, molded, provided or engraved to a stamper's surface by etching or engraving key image features or engraving to capture image edges or contrast areas, etc.

Halftone Watermarking

In the above-mentioned patent application Ser. Nos. 09/689,226, 10/052,895, and 09/840,016 assignee discloses many halftone watermarking techniques. Such halftone watermarking techniques can be alternatively used to embed a digital watermark within an image. The embedded halftone image is used as a pattern template for the stamper stamp surface.

Additional Applications

I noted several applications for my digitally watermarked stamper in the Invention Summary above. An additional application is to use a digitally watermarked stamper as an authentication tool. For example, a notary may have a digitally watermarked stamper that includes an embedded payload. The payload may correspond to the notary's registration number, notary's jurisdiction or commission expiration date. If someone tries to forge the stamp, it may not include the appropriate steganographically embedded payload. Similarly, an embassy, immigration office, boarder station or other government agency may include a stamper that uniquely identifies the station, embassy, officer, agency, etc. Then, if a stamper is misappropriated (or copied), stamps produced by the misappropriated stamper can be identified as corresponding to misappropriated stamper. Instead of replacing all related stampers, the misappropriated stamper (via its digital watermark identifier) can be flagged. People having passports or visas including the misappropriated identifier can be queried to help track down the missing stamper. Or random checks of, e.g., passports or immigration papers, can include searching for an expected digital watermark payload.

A digital watermark payload can carry a vast variety of information. In one implementation, the payload carries an identifier. The identifier uniquely identifies the stamper or an organization or individual to whom the stamper belongs, etc. In another implementation, the payload includes a machine-enabling link or instruction as discussed above. In still another implementation, the payload includes a date or time stamp. (Or in a related implementation, the payload includes a “valid until” indicator. For example, the payload indicates that the stamp is valid until April 15^{th}, or for 10 days, etc.). Still further the payload includes geo-location information or a security level or security clearance associated with the stamped paper or object. The geo-location information, once retrieved from a steganographic signal, can be evaluated to help determined, e.g., whether a stamped document or object is found in an unexpected (or unauthorized) geo-location.

Conclusion

The foregoing are just exemplary implementations of the present invention. It will be recognized that there are a great number of variations on these basic themes. The foregoing illustrates but a few applications of the detailed technology. There are many others. Please note that the linking features disclosed in assignee's U.S. patent Ser. No. 09/571,422 can be employed with a digital watermark conveyed through a stamper.

To provide a comprehensive disclosure without unduly lengthening this specification, applicants incorporate by reference, in their entireties, the disclosures of the above-cited patent documents. The particular combinations of elements and features in the above-detailed embodiments are exemplary only; the interchanging and substitution of these teachings with other teachings in this application and the incorporated-by-reference patents/applications are expressly contemplated.

Although not belabored herein, artisans will understand that the embedding and decoding systems and methods described above can be implemented using a variety of hardware and software systems. Alternatively, dedicated hardware, or programmable logic circuits, can be employed for such operations.

The various section headings in this application are provided for the reader's convenience and provide no substantive limitations. The features found in one section may be readily combined with those features in another section.

In view of the wide variety of embodiments to which the principles and features discussed above can be applied, it should be apparent that the detailed embodiments are illustrative only and should not be taken as limiting the scope of the invention. Rather, I claim as my invention all such modifications as may come within the scope and spirit of the following claims and equivalents thereof.

What is claimed is:

1. A method comprising the steps of:
providing a digital watermark signal;
thresholding the digital watermark signal to yield a set of points, wherein the set of points is machine-readable;
embedding the thresholded digital watermark signal in a 1-bit per pixel pattern; and
patterning a stamper stamp surface after the embedded digital watermarked 1-bit per pixel pattern.

2. The method of claim 1, wherein the set of points conveys a plural-bit payload.

3. The method of claim 2, wherein the payload comprise geo-location information.

4. The method of claim 2, wherein the payload comprises an authentication clue.

5. The method of claim 2, wherein the payload comprises or points to an internet address.

6. The method of claim 2, wherein the payload comprises an email address.

7. A method of manufacturing a stamper comprising the steps of:
receiving a digitally watermarked image;
using the digitally watermarked image as a template for patterning a surface which is to be used as a stamper stamp surface, the result of the patterning corresponding to the digitally watermarked image; and
providing the patterned surface as a stamper stamp surface.

8. The method of claim 7, wherein a digital watermark embedded within the image comprises an identifier, wherein the identifier survives transfer to a document when the stamper is used to stamp the stamper stamp surface against the document.

9. The method of claim 8, wherein the transfer is aided by at least one of ink and dye.

10. A method of uniquely identifying a stamper comprising the steps of:
providing a digital watermark having a payload, the payload including identifying data;
embedding the digital watermark in a pattern or image; and
shaping a stamper surface pattern in accordance with the digitally watermarked pattern or image, wherein a stamp produced by the stamper produces the pattern or image including the digital watermark.

11. The method of claim 10, wherein the identifying data comprises geo-location data.

12. The method of claim 10, wherein the identifying data comprises a time-stamp.

13. The method of claim 10, wherein the identifying data comprises a security clearance requirement.

14. The method of claim 10, wherein the identifying data comprises at least one of an email address and an internet address.

15. A stamper comprising a handle and a surface, wherein the surface comprises a surface pattern formed by at least one of etching, molding and engraving, the surface pattern being patterned after a first pattern, wherein the first pattern includes a steganographic signal embedded therein, the surface pattern including the embedded steganographic signal, and wherein the embedded steganographic signal is generally visually imperceptible but remains machine-readable.

16. The stamper of claim 15, wherein the steganographic signal comprises a digital watermark.

17. The stamper of claim 16, wherein the digital watermark includes a spread-spectrum modulated message.

18. The stamper of claim 16, wherein the digital watermark further comprises an orientation component.

19. A rubber stamp-making process including:
defining a two-dimensional signal that encodes plural bits of data; and
shaping a rubber stamp pattern in accordance with said signal.

20. The process of claim 19, wherein the plural bits of data comprises at least one of a geolocation and a pointer to a geolocation.
